(19) United States
(12) Patent Application Publication
(10) Pub. No.: US 2026/0329927 A1
(43) Pub. Date: Oct. 22, 2026

(54) SYSTEM AND METHOD FOR INTERPRETING SIGN RULE ENTITIES

(71) Applicant: Park Clear LLC, Pasadena, CA (US)

(72) Inventor: Loan Thanh Nguyen, Pasadena, CA (US)

(73) Assignee: Park Clear LLC, Pasadena, CA (US)

(21) Appl. No.: 19/648,882

(22) Filed: Apr. 15, 2026

Related U.S. Application Data
(60) Provisional application No. 63/789,592, filed on Apr. 16, 2025.

(51) Int. Cl. G06F 16/387; G06F 21/62; G06V 20/58; G06V 20/62; G06V 30/10; G08G 1/14

(52) U.S. Cl. CPC G06F 16/387; G06F 21/6254; G06V 20/582; G06V 20/62; G06V 30/10; G08G 1/144

(57) ABSTRACT

A computer-implemented system and method that interprets municipal street parking tangible or intangible sign rules to provide a binary indication of permissibility at a refined curb-side location and query time. A user interface, location module, enhanced metadata module that refines GPS-based position using supplemental signals, time module, and signage database storing geospatially keyed, time-dependent street tangible or intangible sign rules with priority values are coupled to a rule-interpretation processing engine. The processing engine retrieves sign records for the refined location, resolves overlapping rules according to the priority scheme, and outputs a yes/no indication with an explanatory message. Additional modules support sign-image acquisition and image-analysis-based rule extraction, analytics, feedback, availability overlays, payment initiation, and limited-connectivity local caching, while the binary permissibility indication itself is derived from the encoded sign and curb-use rules rather than from probabilistic parking-availability estimates based on vehicle trajectory or occupancy statistics.

### CROSS-REFERENCE TO RELATED APPLICATIONS

This application claims the benefit of U.S. Provisional Patent Application No. 63/789,592 entitled: System and Method for Real-Time and Predictive Street Parking Availability Visualization Using Color-Coded Geospatial Mapping Based on Municipal Parking Regulations and Dynamic Data Integration, filed Apr. 16, 2025 the entire contents of each of which are incorporated herein by reference in their entireties.

### STATEMENT REGARDING FEDERALLY SPONSORED RESEARCH AND DEVELOPMENT

Not Applicable.

### BACKGROUND OF THE INVENTION

### Field of the Invention

The present invention relates generally to the field of intelligent transportation systems and urban mobility technology, and more particularly to computer-implemented methods and systems for interpreting tangible or intangible street parking sign rules to determine parking compliance and, or rule at specific curb-side locations and times.

### Discussion of Related Art

Existing parking and smart-mobility systems address only portions of the problem that arises when drivers attempt to understand complex, time-varying municipal street parking regulations at a specific curb location. Traditional parking guidance and availability systems, such as those estimating on-street parking availability per segment or routing drivers to likely open spaces, focus on probabilistic availability using GPS traces, sensor networks, or user reports, but do not interpret municipal street parking sign text or generate a binary legal/illegal determination keyed to a refined geolocation and query time. These systems generally lack a canonical signage database with detailed curb-use rules, rule-priority values, and explicit handling of overlapping regulations, and therefore cannot reliably answer whether a particular space is legally usable by a given driver at a given time. In particular, such systems typically assign vehicle trajectories or probe traces to relatively coarse street segments and infer a likelihood of parking availability from user density statistics on those segments, rather than from the authoritative content of municipal curb-use regulations encoded from street parking signs.

Various mobile applications and research prototypes allow users to view or crowdsource parking rules, or to receive notifications about meter expirations or generic time limits but typically treat sign information as static text or as map annotations without a robust rule-interpretation engine. AI-based parking compliance and, or rule systems for personal mobility vehicles, for example, use user-captured images and machine-learning models together with stored rules to decide whether scooters or bikes are parked within geometric constraints such as distance from a sidewalk or ramp, but they do not ingest municipal street parking sign text and do not compute a yes/no compliance and, or rule result for curb-side automobile parking based on time-dependent regulatory conditions. Likewise, scene-classification and automated-parking driver-assist systems classify environments and detect free spots from camera images to improve automated parking functions but are designed for garages and lots and do not maintain a municipal street-sign database or resolve time-varying curb regulations. Other approaches that estimate curb-side availability from GPS traces of a community of vehicles similarly do not normalize or reconcile overlapping tangible or intangible sign rules, and instead provide segment-level probability scores that are agnostic to the detailed, rule-priority-driven constraints that apply to different vehicle types, permits, or times of day at the same curb-side location.

Digital curb-management and smart-parking platforms maintain city-scale inventories of curb segments, parking locations, or parking meters, and integrate availability sensing, user reservations, payments, and sometimes analytics. These systems may provide map-based displays of spaces, reservations, and meter status, and can send notifications about time limits and potential violations, but they typically rely on user reports, sensor data, or meter state rather than a comprehensive machine-readable signage database of municipal rules keyed to geospatial regions with encoded time-dependent conditions and rule-priority values. They usually do not refine user location using enhanced metadata such as triangular cell-tower data, carrier and device-manufacturer information, or external context feeds, and they do not apply a dedicated rule-interpretation engine to overlapping curb-side tangible or intangible sign rules to produce a binary compliance and, or rule output at a refined curb location and specific time. Moreover, these platforms generally treat availability and enforcement as coupled concepts, where a segment that appears historically “parkable” is presumed usable absent real-time sensor evidence to the contrary, rather than enforcing compliance and, or rule strictly as the outcome of rule interpretation on a sign-centric data model.

Sign-decoder and parking-sign reader applications allow users to capture images of street parking signs and use AI or computer vision to parse text and symbols, returning human-readable explanations of posted rules and, in some cases, a simple indication of whether parking appears to be allowed. Publicly available descriptions of such tools indicate the use of mobile UIs, image capture, geolocation, and rule parsing to provide guidance about time windows and exceptions, but do not disclose an enhanced metadata module that systematically fuses GPS with triangular cell signal data, carrier and device-manufacturer information, and third-party context to derive a refined curb-segment location with an associated confidence level. Nor do they describe a canonical city-scale signage database that, for each record, stores a geospatial region and rule-priority value, together with discrepancy-resolution logic between historical and newly received sign information, structured feedback loops, and a limited-connectivity local cache that supports compliance and, or rule determinations when network access is unavailable. Such tools also do not distinguish between (i) a compliance and, or rule engine that produces a binary, sign-driven permissibility output and (ii) a separate, optional availability layer that may aggregate external occupancy or trace-based signals while leaving the underlying yes/no compliance and, or rule determination unchanged.

Accordingly, no existing system combines, in a unified, sign-centric compliance and, or rule platform: (i) a canonical municipal signage database keyed to geospatial regions with time-varying, vehicle- and permit-specific rules and rule-priority values; (ii) an enhanced metadata module that refines user location by fusing GPS with triangular cell-signal, carrier, device-manufacturer, and third-party context data and surfaces a confidence level; (iii) a rule-interpretation engine that resolves overlapping street parking tangible or intangible sign rules and outputs a binary parking permissibility result with explanatory context at a refined curb-side location and query time; and (iv) a feedback-driven maintenance loop, analytics, and optional availability and payment integration that continuously update and operationalize that database across mobile, web, and in-vehicle interfaces. The present invention addresses this gap. In certain embodiments, the present invention further separates compliance and, or rule computation from any probabilistic availability estimation by computing the binary permissibility result solely from encoded tangible or intangible sign rules and associated geospatial regions, and by treating availability or occupancy predictions as an optional, downstream dimension that does not alter the underlying legal/illegal outcome at a given curb-side point.

### SUMMARY

The present invention provides a computer-implemented system and method for interpreting municipal street parking tangible or intangible sign rules and delivering a binary, explainable parking permissibility determination at a refined curb-side location and query time. The system integrates a user interface, a location module, an enhanced metadata module, a time module, a canonical signage database storing geospatially keyed, time-varying parking rules, and a rule-interpretation processing engine that resolves overlapping and potentially conflicting sign regulations to output a yes/no parking permissibility indication with explanatory context. In certain embodiments, the system further incorporates analytics, feedback, availability, and payment modules that log historical parking determinations, ingest user and image-based updates, and initiate parking transactions when permissible fee-based parking is detected. Unlike prior systems that estimate on-street parking availability by aligning vehicle trajectories to street segments and computing segment-level parking probability values, the present invention's compliance and, or rule determination is grounded in the structured municipal tangible or intangible sign rules themselves and can be generated in the absence of any historical vehicle trace data, with availability-related information, where present, being layered as an optional, non-determinative attribute.

In preferred embodiments, the system is deployed as a multi-platform application executing on at least one of a mobile device, a web browser, and an in-vehicle or kiosk interface, receiving user parking queries that include at least location information and optionally user profiles and desired parking times. A location module determines an initial geographic position using at least GPS, manual entry, QR-code input, voice input, or navigation-application data, and an enhanced metadata module refines this position using triangular cell signal measurements, cellular-carrier data, device-manufacturer information, and third-party context such as local events, construction, and traffic to associate the query with a specific curb segment and to compute a confidence level. A time module determines a query time comprising a current time or user-specified date and time, and a processing engine queries the signage database to identify one or more parking sign records whose stored geospatial regions overlap the refined location. The processing engine normalizes and interprets the retrieved sign records, applies rule-priority values and jurisdiction-specific precedence policies to resolve conflicts among overlapping rules, and generates a binary parking permissibility output together with a textual explanation that may include time limits, special conditions, confidence indicators, availability context, and next permissible parking intervals. In particular, the processing engine is configured to treat the availability context, when present, as informational guidance that may influence user interface elements such as color shading or recommended alternatives, while the yes/no permissibility output itself remains determined exclusively by the encoded tangible or intangible sign rules and rule-priority framework.

In certain embodiments, the system further comprises an image-processing module configured to extract text and structured rule information from user-captured images of parking signs and to update the signage database or flag discrepancies between newly observed signage and existing records. A feedback module receives user feedback regarding the accuracy of compliance and, or rule determinations and adjusts at least one of the signage database and rule-interpretation logic based on aggregated feedback and historical parking outcomes, thereby providing a self-healing rule-maintenance loop. An analytics module logs parking queries, refined locations, query times, and binary outputs to generate historical parking trend information for one or more regions and to support improved availability estimation. In some embodiments, a limited-connectivity mode uses a local cache of sign data and rule logic stored on the user device to generate permissibility outputs when communication with the central signage database is unavailable, and a payment module initiates parking payment transactions with third-party services upon determining that parking is legally permitted and fee-bearing. Because compliance and, or rule is evaluated on the basis of sign-encoded regulations, the limited-connectivity mode can continue to deliver correct yes/no results for curb-side locations even when no network-supplied availability signals or recent crowd-sourced trajectory data are available for those locations.

### BRIEF DESCRIPTION OF THE FIGURES

The accompanying drawings illustrate various embodiments and along with the description, help explain the principles of the method. It is understood by those skilled in the art that the specific arrangements shown in the drawings are merely examples and should not be considered as limiting the scope of the method or the claims in any way.

FIG. 1A: Overall system architecture (Phase I: reactive).

FIG. 1B: Overall system architecture (Phase II: predictive).

FIG. 2A: Parking query lifecycle (request and routing).

FIG. 2B: Parking query lifecycle (result delivery and notifications).

FIG. 3A: Signage data model.

FIG. 3B: Rule resolution workflow for overlapping rules.

FIG. 3C: Priority-based safety-first rule resolution.

FIG. 3D: Rule resolution decision ladder.

FIG. 4A: Image processing and rule extraction pipeline.

FIG. 4B: Metadata schema and rule database routing.

FIG. 5A: User/session lifecycle (app launch and input).

FIG. 5B: User/session lifecycle (evaluation and notifications).

FIG. 6A: Primary query input screen.

FIG. 6B: Sign-scan and image upload screen.

FIG. 6C: Map-based parking compliance and, or rule and forecast screen.

### DETAILED DESCRIPTION

### Core System Architecture and Functionality

The present invention discloses a computer-implemented, location-aware intelligent street-parking interpretation system and method. The system integrates a multi-channel user interface, a location determination module, an enhanced metadata refinement module, a time module, a rule-interpretation processing engine, a signage database, and optional analytics, feedback, availability, and payment modules to enable users to obtain a binary, explainable determination of on-street parking permissibility at a given place and time, even in the presence of overlapping, conflicting, or dynamically changing municipal parking rules. The architecture is expressly designed so that compliance and, or rule determinations are computed from sign-and regulation-derived rule records in the signage database via the rule-interpretation processing engine, without requiring any computation of a probabilistic parking availability metric along a street segment, thereby allowing the system to remain authoritative and deterministic in locations or time windows where no reliable availability telemetry exists or where occupancy-based signals would otherwise be misleading.

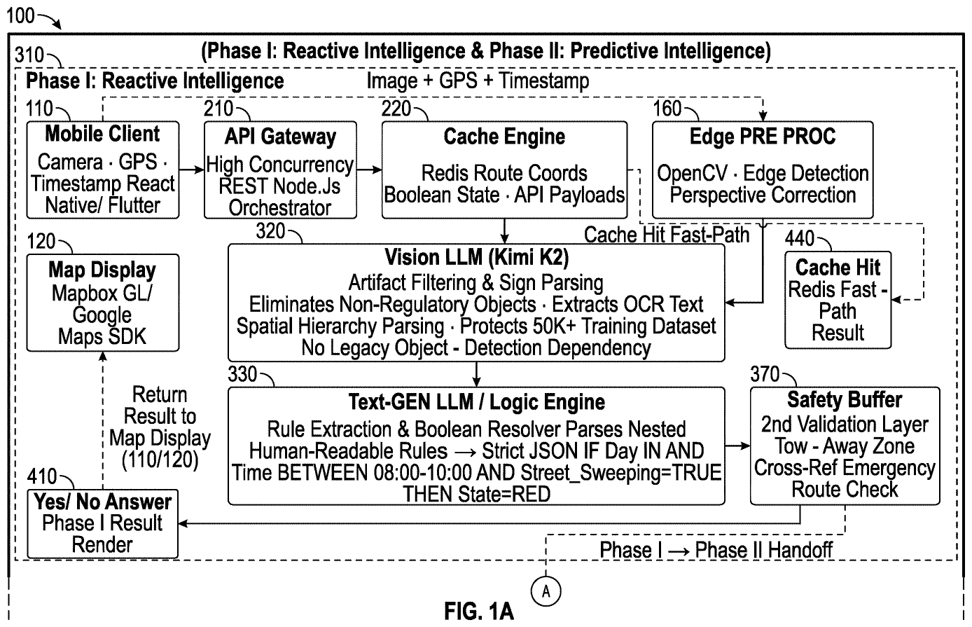

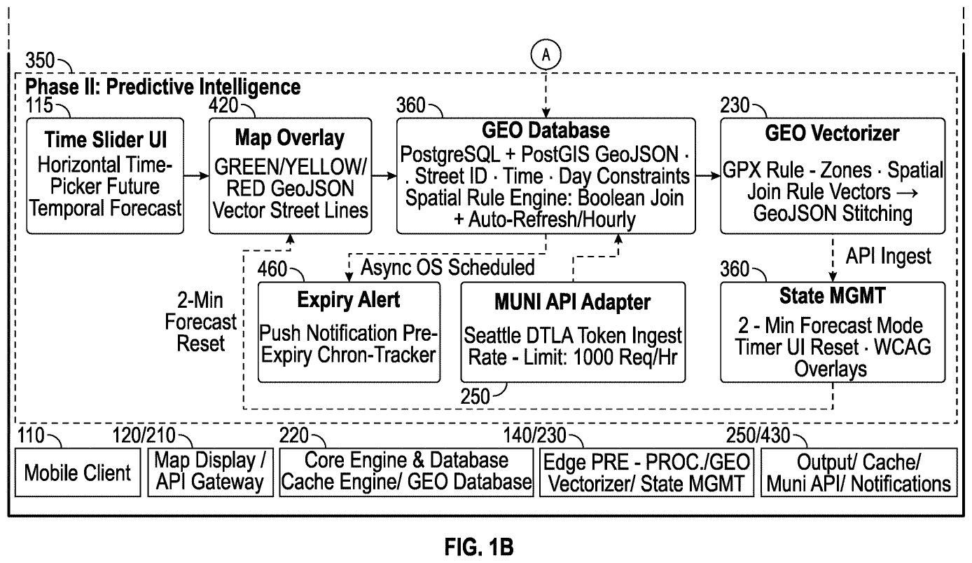

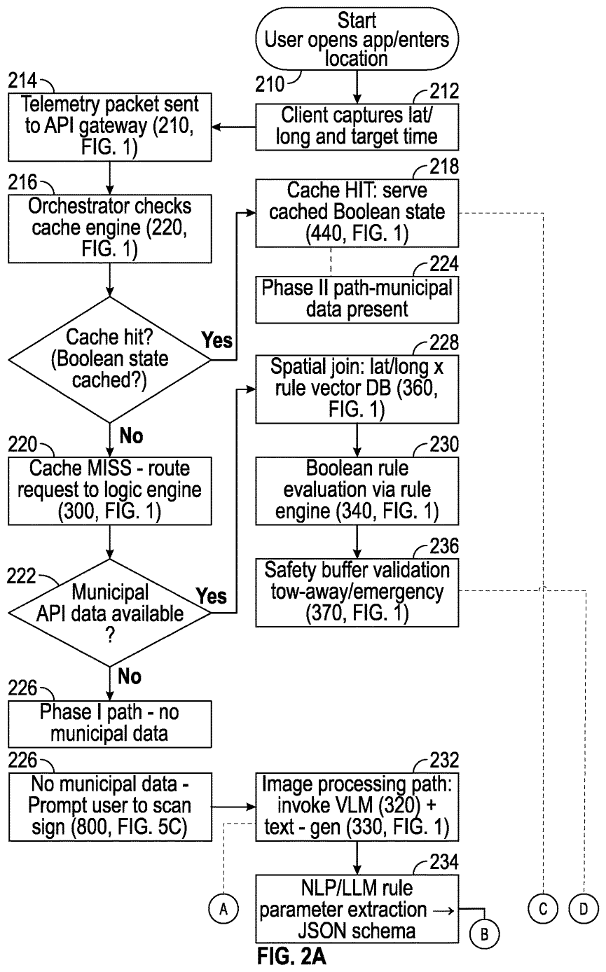

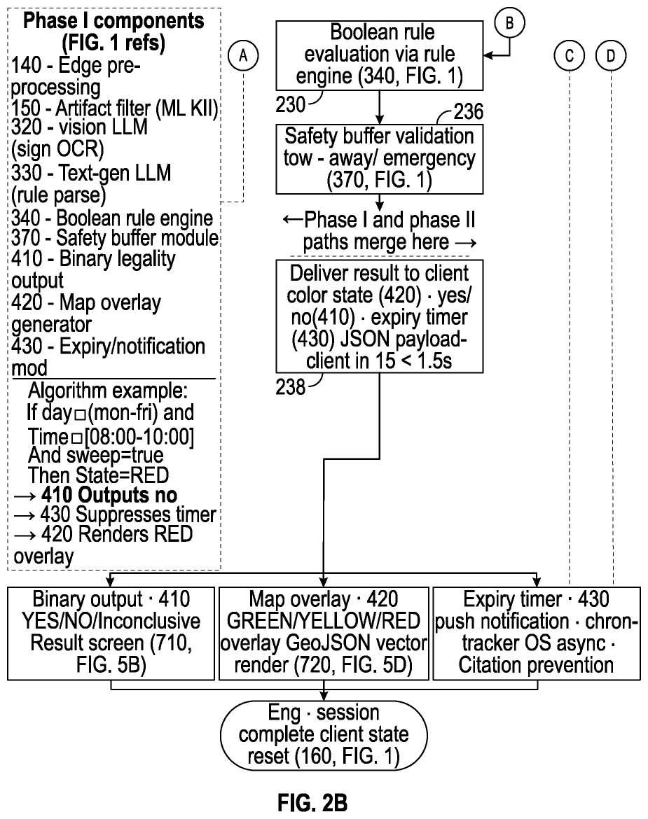

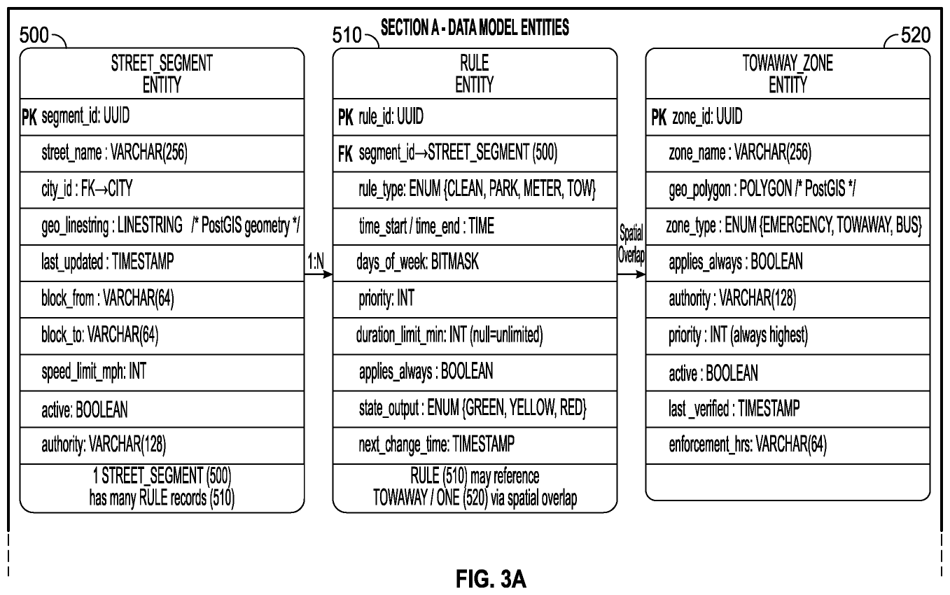

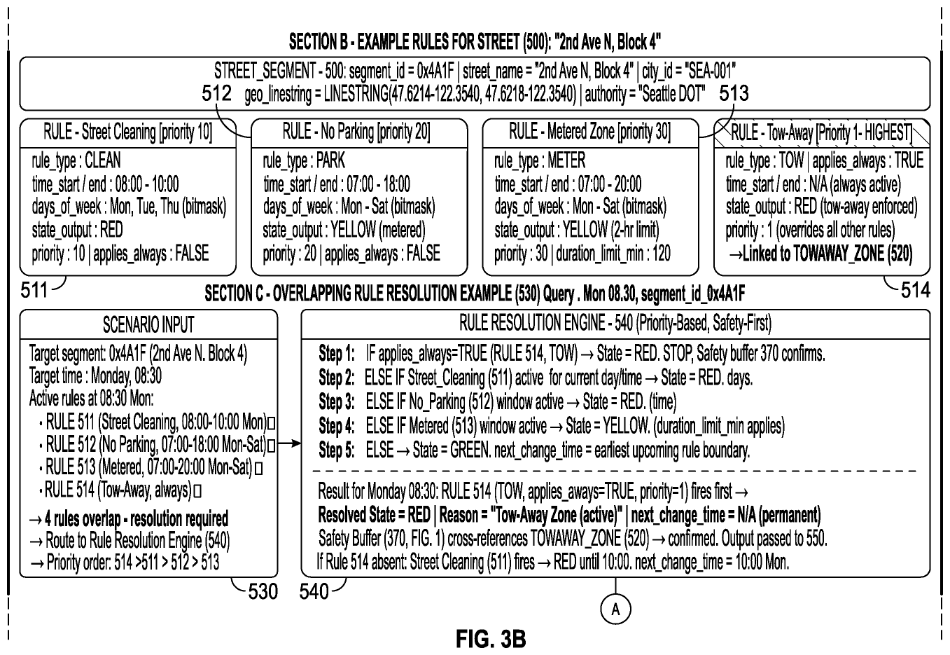

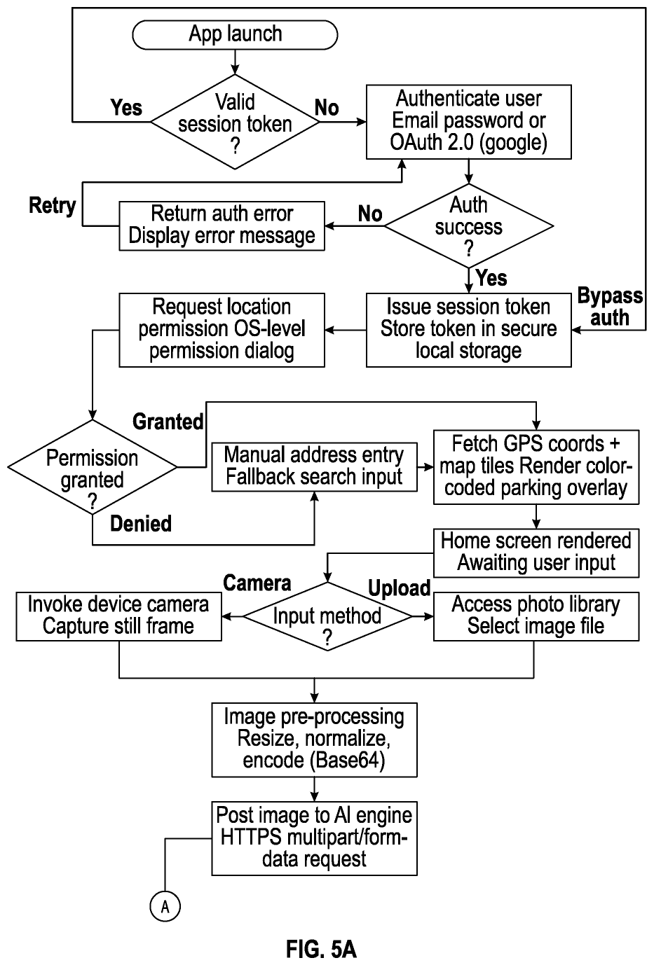

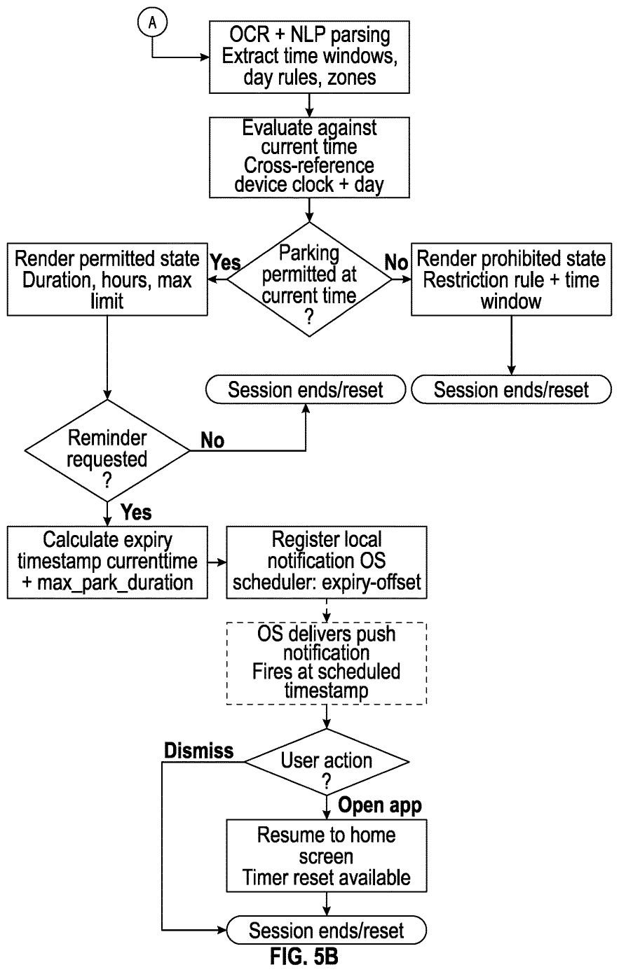

As illustrated in FIG. 1A and FIG. 1B, the overall architecture comprises a modular, layered structure. A user-facing interface at the top layer executes on at least one of a mobile device, a web browser, and a standalone street kiosk (collectively shown as a mobile client 110, map display 120, and associated user interface flows in FIG. 5A-5B) and provides functionality for receiving parking queries, capturing or uploading images of parking signs, presenting binary permissibility outputs, and surfacing textual explanations, notifications, and, where available, non-controlling availability information. A location module acquires coarse geographic coordinates using at least one of global positioning system (GPS) data, manual entry, QR code input, voice input, and data received from a navigation application (as in the client telemetry to an API gateway 210 in FIG. 1A and FIG. 2A), while an enhanced metadata module refines this location using triangulated cellular-signal data, cellular-carrier information, third-party data sources, and device-manufacturer-specific data to determine a refined geographic location associated with the user's vehicle or prospective parking position. A time module determines a query time, which may include the current date and time derived from a device or server clock or a user-specified date and time for future or historical parking evaluation (for example, via a time-slider user interface 115 shown in FIG. 1B), thereby enabling both real-time and predictive compliance checks.

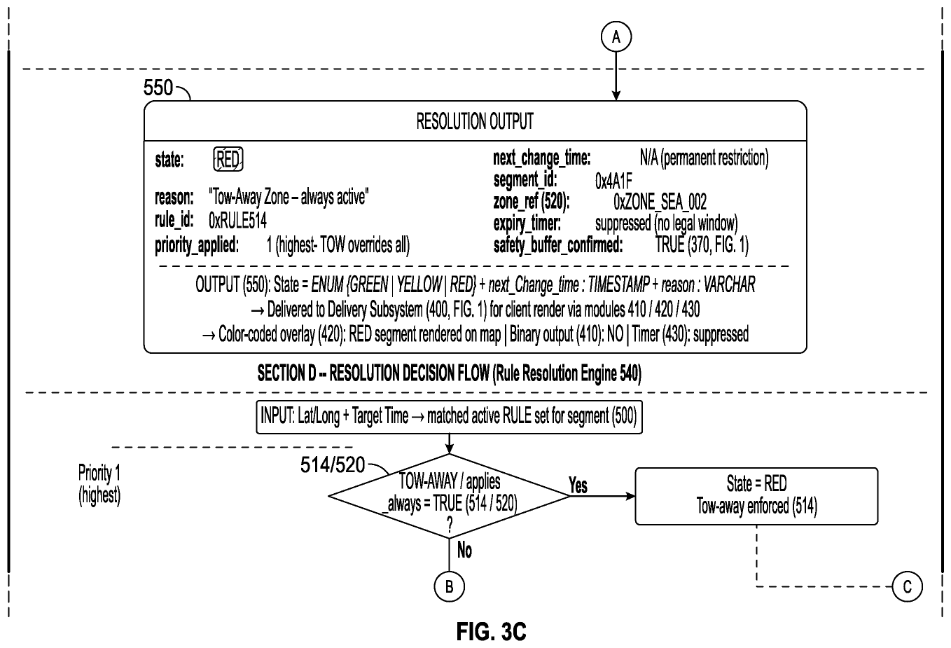

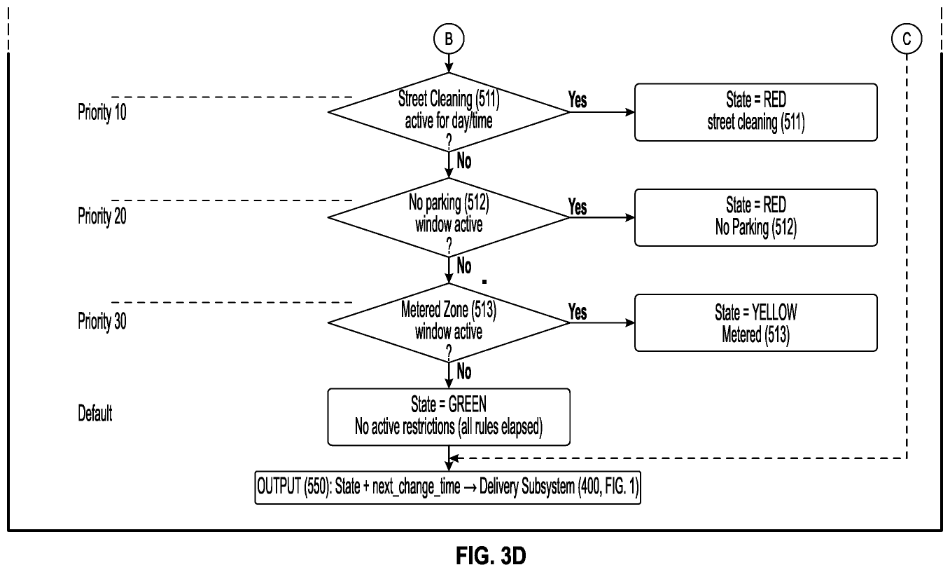

The system further includes a signage database storing structured street-parking sign and curb-use rule records for a plurality of municipal locations, including rule text, encoded restrictions, time-dependent conditions, associated geospatial regions, vehicle-type and permit conditions, and, in certain embodiments, rule priority values used for conflict resolution, as reflected in the data-model entities 500, 510, and 520 in FIG. 3A. A central processing engine couples to the user interface, location module, enhanced metadata module, time module, and signage database, and implements a rule-interpretation workflow that identifies relevant sign and rule records for the refined geographic location, interprets any overlapping or conflicting rules in view of the query time, and generates a binary parking permissibility output—and associated explanation—for display via the user interface. In at least one embodiment, this processing engine is realized as an orchestrated core engine 220, 300 with a Boolean rule engine 230, 340, a safety buffer module 236, 370, and a delivery subsystem 400 integrating binary compliance and, or rule output 410, a map overlay generator 420, and an expiry/notification module 430, as shown in FIG. 1A, FIG. 2B, and FIG. 3C-3D. The Boolean rule engine 230, 340 operates on normalized sign-and regulation-derived rules and their associated geospatial regions and does not require as input any aggregate vehicle-density statistics, learned occupancy surfaces, or segment-level availability scores that might otherwise be computed from community-wide GPS traces or probe-vehicle data. In this way, third-party availability or occupancy models may be used, where present, only as optional, non-controlling overlays and ranking signals and not as determinants of legal compliance.

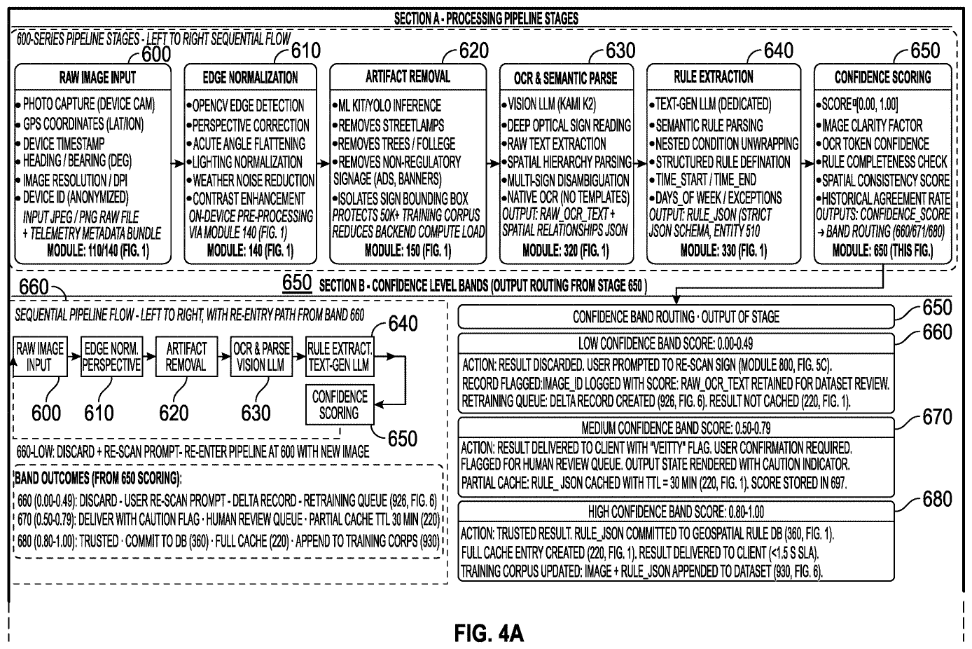

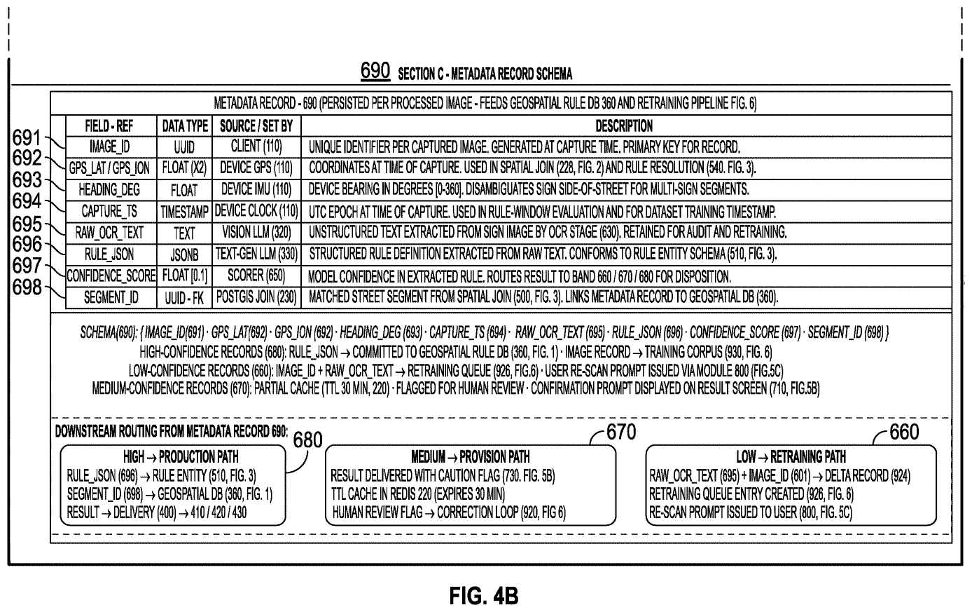

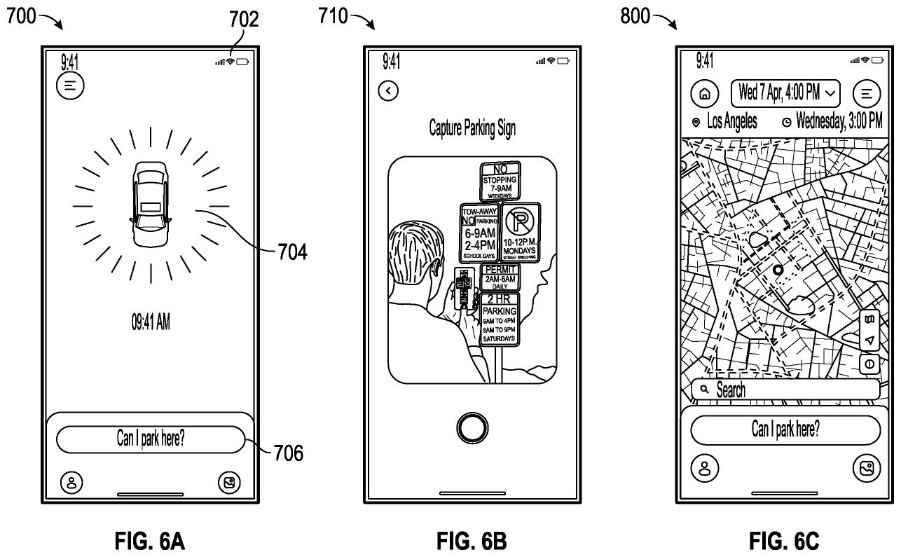

In some embodiments, the system includes an image processing module configured to extract machine-readable text and metadata from user-submitted parking sign images, as illustrated by the edge pre-processing 140, 610, artifact removal module 150, 620, vision LLM 320, 630, and text-generation LLM 330, 640 pipeline stages in FIG. 1A and FIG. 4A-4B. This module is configured to handle single-sign and multi-sign stacks, to identify spatial ordering and grouping of sign panels, and to convert such visual structures into corresponding structured rule elements. An analytics module is configured to log interactions and generate historical parking trend information, including query volumes, typical permissive windows, and inferred violation patterns, while remaining logically separated from the core compliance computation. A feedback module is configured to incorporate user-supplied corrections and training data, as reflected by correction and retraining flows 920, 924, and training corpus updates 930 in FIG. 4B and FIG. 6, enabling the system to improve rule coverage and model performance over time without altering the semantics of the underlying rule-interpretation engine. A payment module may initiate parking payment transactions when a fee-based but permissible parking opportunity is detected and may integrate with third-party payment services through output and notification channels indicated at 250 and 430 in FIG. 1B, with payment initiation being conditioned on both legal permissibility and, in some embodiments, an availability or space-existence indication without allowing any availability prediction to override a legal prohibition. The system is designed for extensibility, supporting operation across multiple municipalities and jurisdictions, diverse sign formats and languages, and integration with in-vehicle systems and third-party navigation and payment platforms. In further embodiments, analytics and trend information derived from historical queries, enforcement records, or external occupancy data are maintained in strict logical and, optionally, physical separation from the core sign-rule store, so that updates to availability-related models do not alter the canonical sign records, their provenance, or the rule-priority semantics used for compliance and, or rule determinations.

### Data Flow Architecture

As shown in FIG. 1A, FIG. 1B, and the flow diagram of FIG. 2A-2B, the data flow architecture is implemented as a modular, event-driven pipeline in which a mobile client captures sensor and telemetry inputs and forwards them via an API gateway 210 to a core orchestration and rule-evaluation backend. A user parking query event begins when the mobile client user interface (modules 110/120 in FIG. 1A) receives user input that includes at least location information, such as a GPS-derived coordinate, a manually entered address, a QR-code identifier associated with a parking zone, or a destination handed off from a navigation application, and transmits a telemetry packet comprising image data, GPS coordinates, timestamp, heading, and optional profile information to the API gateway 210. The API gateway 210 forwards this request to an orchestrator that first consults a cache engine 220 for a fast-path Boolean or enumerated parking state result 440 and, on a cache miss, routes the request to a core engine 220, 300 that includes a geospatial database 228, 360, a rule engine 230, 340, and computer-vision and language-model components 320, 330. In some embodiments, the cache engine 216, 220 stores both direct legality outcomes and intermediate rule snapshots keyed by segment identifiers or geospatial hashes, thereby accelerating repeated queries for similar contexts without modifying the underlying rule logic.

The location module determines an initial geographic location from the user input, and an enhanced metadata module refines this location using triangulated cell signal data, carrier data, device-manufacturer-specific positioning signals, and optional third-party data, such as building footprint maps, curb-segment inventories, or high-definition road graphs, to associate the query with a specific curb segment, side of street, or signed geospatial region corresponding to a street-segment entity 500 in the geospatial database 360. In one implementation, the geospatial database 360 is a PostgreSQL/PostGIS store that maintains GeoJSON line-string geometries and street identifiers for street-segment entities 500, along with time- and day-constrained rule vectors for rule entities 510 and, where applicable, overlapping tow-away-zone entities 520 referenced via spatial-overlap relations. The refined curb-side locations are therefore matched, via spatial joins, to one or more street-segment entities 500 in the geospatial database 360, which serves as an index between refined locations and sign-derived rule vectors stored as structured JSON rule entities 510 in the signage or geospatial rule database, rather than as a container of segment-level parking probabilities derived from probe-vehicle traces or anonymized trip endpoints.

In parallel with location refinement, the time module determines a query time by capturing the current date and time from the user device or server, or by applying a user-specified date and time for forward-looking or retrospective analysis, consistent with the temporal evaluation flow of FIG. 5B. The processing engine then queries the signage database with the refined geographic location and retrieves one or more sign, or rule records whose associated geospatial regions intersect or overlap with the refined location, using spatial-join operations as shown at steps 228, 360 and 230, 340 in FIG. 2A and FIG. 3A-3B. The retrieved records may include multiple restrictions applicable to the same curb segment, such as alternate-side parking rules, street-cleaning windows, residential-permit restrictions, loading-zone windows, commercial-vehicle rules, and event-based or emergency restrictions. Because the lookup is performed against rule-encoded sign records and official curb-use regulations rather than against availability surfaces or inferred probability maps, the system can correctly determine that certain curb segments are legally unusable even where historical vehicle traces would suggest low occupancy or high physical availability.

The rule-interpretation module within the processing engine applies a multi-stage interpretation pipeline. First, it normalizes the retrieved sign and regulation records into a structured rule representation with explicit date, time-of-day, day-of-week, permit, vehicle-type, zone-type, and special-condition fields, conforming to a rule entity schema such as 510 in FIG. 3A and rule JSON structures 696 in metadata record 690 of FIG. 4B. Second, it applies conflict-resolution logic that may use rule-priority values, explicit override markers, safety classifications, or jurisdiction-specific precedence rules to produce an effective rule set at the refined geographic location and query time, as implemented by the rule resolution engine 540 and decision flows in FIG. 3B-3D. Third, it evaluates the effective rule set against the query time and, optionally, user-profile constraints such as vehicle type, permit ownership, or accessibility preferences to determine whether parking is permitted, prohibited, or allowed subject to time, permit, or payment conditions. At no stage of this interpretation pipeline is a street-segment-level parking probability, user-density metric, or occupancy forecast required or used as a determinant of compliance and, or rule; instead, any such metrics, when available, may be consulted only for ancillary guidance, such as ranking alternative legally permissible locations, rendering shaded availability overlays, or prioritizing suggested destinations.

Based on this evaluation, the processing engine generates a binary parking-permissibility output indicating whether parking is permitted at the refined geographic location at the query time and may also generate a textual explanation that includes a time limit, special condition, and next permissible parking interval or next change in state. The user interface presents this output using a simple yes/no indication and explanatory text and, in some embodiments, a visual indicator such as color-coded signals or map overlays, as shown by the result screen 710, caution flag 730, and map overlay 720 in FIG. 5B-5D. User queries, refined locations, rule interpretations, confidence levels, and outputs are logged by the analytics module to support historical trend analysis, system diagnostics, and ongoing system improvement. In some embodiments, map overlays may further encode, with different hues, opacities, or line styles, availability-related information that is statistically inferred from sensor data, parking-meter telemetry, enforcement records, or historical usage; however, the binary compliance and, or rule output displayed for a given point on the map remains governed solely by the underlying interpreted sign and regulation rules, such that availability indicators cannot visually or programmatically override a legally prohibitive state.

The architecture is designed to operate over cloud-native or hybrid infrastructure using containerized microservices, message queues, and asynchronous job schedulers, enabling scalable deployment across many cities and high query volumes, as suggested by the high-concurrency API gateway 210, cache engine 220, and asynchronous OS-scheduled events 250 in FIG. 1B. In certain embodiments, at least a portion of the signage database and rule-interpretation logic is cached on the user device, allowing a limited-connectivity mode in which binary permissibility outputs are generated locally when network communication with the central signage database is unavailable, using fast-path cache results 218, 440 from FIG. 1A and FIG. 2A. Because the cache stores sign- and regulation-derived rules and derived compliance and, or rule outcomes rather than volatile availability probabilities, the limited-connectivity mode can continue to enforce safety-critical and time-dependent parking prohibitions, such as tow-away zones, rush-hour no-stopping windows, and street-cleaning periods, even where recent probe-vehicle data is missing, stale, or contradictory.

FIG. 2A-2B and FIG. 3A-3D illustrates the rule-interpretation workflow implemented by the processing engine. Upon receipt of a refined geographic location and query time, the engine identifies candidate parking sign and rule records from the signage database by performing a geospatial lookup using the refined location and one or more geospatial indices, such as point-in-polygon tests against curb-segment polygons, block-face line segments, or circular or buffered regions around signage poles, represented by street-segment geometries 500 and tow-away zone entities 520. Each parking sign record stored in the signage database may include: (a) a geospatial region definition; (b) associated rule text and parsed rule structure; (c) time-dependent components such as days of week, hours of day, date ranges, and recurring patterns; (d) vehicle-type conditions, such as commercial-vehicle or residential-permit requirements; (e) zone-type conditions such as bus lanes or loading zones; and (f) a rule priority value or other precedence indicator indicating precedence relative to overlapping rules, as exemplified by rules 511, 512, 513, and 514 in FIG. 3B-3D. The rule vectors associated with these records are anchored to specific municipal sign artifacts, published curb-use regulations, or validated user observations and are not generated by unsupervised clustering of vehicle trace endpoints, learned occupancy fields, or purely statistical inference over GPS-derived stopping patterns.

The rule-interpretation module converts the retrieved sign and regulation records into normalized logical rules and evaluates them at the query time. In embodiments where time-dependent restrictions include alternate-side parking, street-cleaning windows, event-based restrictions, permit-only overnight windows, and time-limited metered parking, the module decomposes each restriction into one or more active intervals, associates each interval with an action (for example, “no parking,” “no standing,” “2-hour limit,” “permit only,” or “tow-away enforced”), and determines whether the query time falls inside or outside each active interval. When two or more rules apply concurrently, the module uses the rule priority values, municipal precedence policies, or explicit override flags to determine the controlling rule, following the priority-based, safety-first decision ladder shown in FIG. 3C-3D, in which safety-critical restrictions such as tow-away zones and no-stopping windows override less-restrictive metered or permit-only rules. In further embodiments, the module is configured to reject, down-weight, or flag as advisory only any availability-driven suggestion that conflicts with a higher-priority legal restriction, such that a curb segment is never treated as legally usable solely because it appears historically under-utilized in vehicle trace data or availability models.

The engine then computes a binary parking-permissibility outcome by applying the controlling rule or combination of rules to the query context. For example, if a street-cleaning prohibition overlaps with an otherwise permissive residential-permit rule, the engine may determine that parking is not permitted during the street-cleaning window even if the user has a residential permit, analogous to the example segment 0x4A1F (2nd Ave N. Block 4) and overlapping rules 511-514 in FIG. 3B. In some embodiments, the engine also calculates the remaining permissible parking duration before a restrictive period begins and determines a next permissible parking interval if parking is currently not allowed, enabling the generation of user-friendly explanations and expiry timers managed by the notification module 430. Because the underlying computation is Boolean and rule-driven, the resulting outcome is deterministic for a given set of sign records and query parameters and does not vary with fluctuating vehicle-density measurements, evolving availability models, or changes in predictive demand algorithms, thus providing a stable compliance surface even as auxiliary analytics evolve.

The signage database may be populated and updated using multiple sources, including municipal data feeds that provide official curb-use regulations, user-submitted sign images processed by the image processing module (pipeline 600-650 and metadata record 690 in FIG. 4A-4B), and user corrections or feedback regarding perceived inaccuracies (feedback loops 920, 924, 926 and UI elements 700-706 in FIG. 6A-6C). The processing engine is configured to resolve discrepancies between historical parking data, availability models, and newly received sign information by applying update policies that may include temporal versioning of sign records, municipal source precedence, source-specific confidence weights, and crowdsourced confidence scores, ensuring that interpretations use the most reliable and up-to-date rule set available for each geospatial region while preserving auditability. In some embodiments, the system stores a provenance indicator with each rule vector that identifies the originating municipal source, sign observation, or combination thereof, enabling auditors to distinguish sign-derived rules from any optional availability-related layers and to verify that compliance and, or rule decisions remain rooted in authoritative regulatory content rather than inferred behaviors.

### Enhanced Metadata, Availability, and Limited-Connectivity Operation

FIG. 1A, FIG. 1B, and FIG. 4B collectively illustrate the enhanced metadata refinement and availability determination components. The enhanced metadata module receives an initial geographic location from the location module and applies one or more refinement steps. These may include: triangulating cell tower signal strengths from multiple towers to infer a more precise curb-side location; incorporating cellular-carrier-specific network topology; using device-manufacturer-provided positioning aids such as Wi-Fi access point maps and inertial measurement units; and reconciling the user's heading or movement vector with nearby curb segments, as captured by heading degrees 693 and GPS coordinates 692 within metadata record 690. Based on the quality and consistency of these signals, the enhanced metadata module computes a confidence level associated with the refined geographic location and passes this confidence value to the user interface for presentation alongside the binary permissibility output, consistent with confidence bands 660, 670, 680 in FIG. 4A. The refined geographic location and its confidence level are applied to select and, in some implementations, weight sign and rule records for compliance and, or rule evaluation, rather than to estimate a probability that another driver recently vacated or will vacate a particular curb-side spot.

In certain embodiments, the enhanced metadata module further integrates local event data, construction data, road-closure feeds, and traffic data provided by third-party services. The module correlates these data sources with the refined geographic location to infer short-term or temporary changes in parking availability or legality, such as lanes blocked for parades, temporary construction zones, incident-related closures, or event-related parking prohibitions. The processing engine uses this information to produce availability information, which may include a qualitative or quantitative indication of likely space availability, temporary constraints, or expected demand, and the user interface presents this availability information together with the binary parking permissibility output, for example via color-coded GeoJSON vector overlays rendered by module 420 in FIG. 1B. In some implementations, the system presents a multi-layer map where an upper, controlling layer visualizes legal permissibility from sign and regulation rules and a separate, non-controlling layer visualizes availability estimates, density gradients, or predicted turnover, thereby preventing users or downstream systems from conflating legal restrictions with probabilistic chances of finding an open space.

To support robust operation when network connectivity is intermittent or absent, the system may download and maintain a local cache of parking sign data, rule entities, and rule-interpretation logic on the user device. In a limited-connectivity mode, the processing engine operates against this local cache, using the same rule-interpretation workflow to generate binary permissibility outputs without requiring real-time access to the central signage database, leveraging cache engine 220 and fast-path result 218, 440 as shown in FIG. 1A and FIG. 2A. When connectivity is restored, the local cache may be synchronized with the central database, and any cached queries and outcomes may be uploaded to the analytics module for incorporation into historical trend data and data-quality diagnostics. Because the cached content comprises sign- and regulation-derived rules and compliance and, or rule outcomes, the limited-connectivity mode does not depend on continuous ingestion of probe-vehicle or sensor-based availability data and can continue to enforce static and recurring restrictions such as tow-away zones, school-day windows, and street cleaning periods.

### Image Processing, Feedback, Analytics, Notifications, and Profiles

FIG. 1A and FIG. 4A-4B illustrate the image processing, feedback, analytics, and notification subsystems. In some embodiments, the user interface allows a user to capture or upload an image of one or more street parking signs visible at or near the refined geographic location, as depicted in FIG. 5A and FIG. 6A-6C. The image processing module applies optical character recognition (OCR) and, optionally, computer-vision models trained to detect and segment parking sign regions, recognize sign templates and shapes, and extract structured rule elements from the image, following a pipeline from raw image input 600 through artifact removal 150, vision LLM 320, text-gen LLM 330, and confidence scoring 650. Extracted text and structured rules are normalized and compared against existing sign records in the signage database; discrepancies may trigger database updates, new sign record creation, correction flows, or flags for human or municipal review (e.g., via delta records 924 and retraining queue 926). As a result, compliance and, or rule computations remain tightly coupled to the most current sign-derived and regulation-derived rules for each curb-side region, and are not inferred indirectly from observed parking behaviors, occupancy predictors, or trace-based proxies.

A feedback module integrated into the user interface allows users to submit feedback regarding the correctness of the binary parking permissibility output and associated explanation. Feedback may include simple confirmations, corrections to time windows, identification of missing or newly installed signs, or reports of inconsistent enforcement, provided through UI elements 700-706 in FIG. 6A-6C. The system aggregates this feedback across users and uses it to adjust confidence scores for specific sign records, prioritize certain municipal data sources, or refine rule-parsing and interpretation heuristics. In some embodiments, highly corroborated user feedback may trigger automated or semi-automated updates to the signage database or may initiate a human-in-the-loop review workflow. In certain jurisdictions, the feedback module can further be configured to flag situations where availability signals suggest frequent use of a curb segment that is legally restricted, supporting municipal review of possible sign damage, missing signage, or inconsistent enforcement while keeping the legal determination grounded in the posted regulations and authoritative data until an authorized rule change is recorded and versioned.

The analytics module logs user interactions, including parking queries, refined locations, query times, binary outputs, confidence indicators, and selected explanations, to build historical parking records. These records can be aggregated to generate parking trend information for one or more geographic regions, such as typical occupancy levels, common violation patterns, or temporal distributions of permissive windows. Such trend information may be exposed through dashboards for municipal planners, third-party partners, or advanced users, and may be used internally to improve availability predictions, to prioritize data-quality efforts in areas with high ticketing or complaint volumes, or to schedule targeted enforcement or signage audits. In some embodiments, analytics data may be used to train or update machine-learning models that forecast demand or availability; however, the outputs of those models are expressly not used as direct inputs to the binary compliance and, or rule computation pipeline, which remains sign- and regulation-rule driven.

The system may further provide proactive user notifications. For example, after determining that parking is currently permitted at the refined geographic location and computing the end of the permissive period, the processing engine can schedule a notification to be transmitted to the user prior to the expiration of the permissive period, using the expiry/notification module 430 and OS-scheduled events 250. The user interface receives and displays this notification, which may include a countdown, the reason for the upcoming restriction (such as street cleaning, tow-away enforcement, or permit-only hours), and recommended actions, as depicted in FIG. 5B-5D. Because the expiration time is derived from the controlling sign rule and associated rule entity 510 rather than from inferred availability, occupancy predictions, or average dwell times, the notification accurately reflects the legal end of the permissive window even where actual occupancy conditions differ from historical patterns.

In certain embodiments, the user interface is configured to receive a user profile comprising at least one of frequently visited locations, vehicle type, accessibility needs, and preferred parking constraints, such as maximum walking distance, avoidance of permit-only zones, or willingness to pay for parking. The processing engine uses the user profile to tailor the binary parking permissibility output and textual explanation, for example by highlighting rules specific to the user's vehicle type, emphasizing permit requirements, or suggesting nearby alternative locations that better satisfy the user's constraints. Suggested alternatives can, in some embodiments, be ranked using availability metrics or predicted occupancy, while still being filtered and constrained by the requirement that they be legally permissible according to the underlying sign and regulation rules and without permitting any availability prediction to override a legal prohibition.

The system can integrate with in-vehicle systems via at least one of Bluetooth, Wi-Fi, and cellular communication. In such embodiments, the user interface can be presented on a dashboard display or in-vehicle infotainment system, and the binary parking permissibility output can be delivered in a form suitable for in-motion consumption, such as a simplified yes/no indicator accompanied by concise audio or visual cues. Vehicle sensor data, such as speed, gear state, ignition state, or steering angle, may also be used to adjust the presentation and interaction model to reduce driver distraction while the vehicle is in operation, for example by suppressing text-heavy explanations when the vehicle is moving and emphasizing color or icon-based cues. In some embodiments, the in-vehicle interface may provide a condensed indication of compliance and, or rule that is independent of any color coding used to depict availability density on a larger-screen map, further reinforcing the distinction between sign-based permissibility and statistical occupancy or crowd-sourced popularity.

When the processing engine determines that parking is permitted at the refined geographic location and that a parking fee or permit purchase is required, a payment module may initiate a parking payment transaction with a third-party parking payment service. The payment module can pre-populate transaction details using the refined geographic location, applicable rate schedule derived from the sign and rule records, and the anticipated parking duration inferred from user input or historical behavior. Upon confirmation of payment, the system may update the textual explanation to reflect the paid status, and, in some embodiments, schedule notifications aligned with the paid parking expiration, using the same expiry and notification infrastructure described above. In embodiments that also consume availability signals, the initiation of a payment transaction may be gated on both legal permissibility and an availability indication; however, the payment decision logic is configured so that an availability prediction can never override a legal prohibition derived from the sign and regulation rules, and so that payment is not offered where a rule-based evaluation yields a prohibitive outcome.

Although specific embodiments have been described in detail, it should be understood that various modifications, substitutions, and alterations may be made without departing from the scope of the system as defined in the appended claims. For example, while the detailed description focuses on municipal street parking signs, analogous techniques can be applied to off-street parking facilities, private-lot restrictions, loading zones, bus lanes, residential access controls, or other forms of curb and right-of-way regulation, and additional data sources and interpretation heuristics may be incorporated as municipal digitization efforts and third-party services evolve. Similarly, while some embodiments may integrate availability- or occupancy-related data streams to improve user guidance, recommendation quality, or route-planning assistance, the scope of the invention as claimed encompasses implementations in which the compliance and, or rule engine operates entirely on sign- and regulation-derived rules and associated geospatial regions, without ingesting any vehicle trace or sensor-based availability inputs, and also encompasses implementations in which such availability inputs are ingested but are constrained to non-controlling, advisory roles that cannot alter the underlying legal determination.

1. A system for interpreting tangible or intangible sign rules and providing guidance to a user, comprising:
a user interface configured to receive user input for a sign-related query including location information and a target time, and to display a binary indication of whether a specified user action is permitted together with a textual explanation;
a location module configured to determine a geographic location associated with the user input;
a signage database storing sign data and associated geospatial regions; and
a processing engine coupled to the user interface, the location module, and the signage database and configured to:
identify one or more sign records associated with the geographic location,
interpret the one or more sign records in view of at least the target time using a rule-interpretation scheme; and
generate, for display via the user interface, the binary indication of whether the specified user action is permitted at the geographic location at the target time together with the textual explanation.

2. The system of claim 1, wherein the textual explanation includes at least one of a time limit, a special condition, and a next permissible time interval, and wherein the specified user action comprises at least one of parking, stopping, standing, loading, entering a restricted street, using a particular lane, and traveling at a specified speed.

3. The system of claim 1, further comprising an enhanced metadata module configured to refine the geographic location using metadata comprising at least one of triangulated cellular-signal data, cellular-carrier data, third-party data, and device-manufacturer data, and to determine a confidence score associated with the refined geographic location for presentation via the user interface.

4. The system of claim 1, wherein the user interface comprises a mobile client application with a time-slider control configured to receive a future time for forecasted parking compliance and, or rule and availability and to display a corresponding updated binary compliance and, or rule indication using a color-coded geospatial map overlay, wherein the color coding of the map overlay optionally reflects availability-related information separate from the binary compliance and, or rule indication, and wherein the user interface executes on at least one of a mobile device, a web browser, an in vehicle infotainment system, and a standalone kiosk.

5. The system of claim 1, wherein the location module is configured to determine the geographic location based on at least one of global positioning system data, manual entry, QR code input, voice input, and navigation application data.

6. The system of claim 1, wherein the signage database stores, for each sign record, a corresponding rule vector representing a street-segment geospatial region and a rule definition specifying at least one of a permitted action, a restricted action, and a time-dependent condition, and a rule priority value used by the processing engine to resolve conflicts between overlapping rule vectors, and wherein each rule vector is derived from at least one municipal curb use regulation or observed sign rather than from clustering of vehicle trajectory traces used to estimate parking availability.

7. The system of claim 1, further comprising a dynamic data integration module configured to receive and process availability-related data comprising at least one of real time sensor data, camera based detections, vehicle telemetry, crowdsourced user reports, and historical occupancy or usage data for geospatial regions associated with signs, and wherein the processing engine is further configured to determine at least one of current availability and predicted future availability for the specified user action within a geospatial region and to generate an availability indication for presentation via the user interface as guidance in combination with, but not as a substitute for or modifier or, the binary compliance and, or rule indication.

8. The system of claim 7, wherein the user interface is configured to present a color-coded geospatial map in which different colors represent at least regions where the specified user action is permitted and currently available, regions where the specified user action is prohibited or unavailable, and regions subject to conditional or special use rules, and wherein the system is further configured to automatically refresh the map overlays at a defined interval and to provide proactive expiration notifications prior to the end of a permissible parking interval.

9. The system of claim 1, further comprising an image processing pipeline including:
an edge side acquisition module configured to capture an image of at least one sign together with localized metadata including a device timestamp and GPS coordinates;
an image normalization module configured to perform at least one of edge detection and perspective correction;
a vision-language or other image-analysis model configured to filter non-regulatory content and extract text and spatial relationships from the normalized image; and
a rule extraction module configured to transform the extracted text and spatial relationships into a structured rule definition for storage in the signage database.

10. The system of claim 9, further comprising a confidence scoring module configured to assign a confidence score to the structured rule definition and to route the structured rule definition to at least one of: a discard and re scan path for low confidence results, a partial cache and human review path for medium confidence results, and a commit to database and training corpus path for high confidence results.

11. The system of claim 1, further comprising an orchestrator component configured to receive requests from the user interface, query a geospatial optimized database storing rule vectors, apply caching for recurring location and time queries, and selectively route each request either to a municipal data interpretation path or to the image processing pipeline when municipal data is unavailable or incomplete.

12. The system of claim 11, wherein the orchestrator component is further configured to:
access municipal application programming interfaces subject to external rate limits;
aggregate curbside policy data into contiguous rule vectors for storage in the signage database; and
serve cached Boolean compliance and, or rule results and corresponding textual explanations for frequently requested locations to reduce latency and external calls, wherein cached Boolean compliance and, or rule results are derived from prior sign rule interpretations and are not stored as availability probability values.

13. The system of claim 1, further comprising a safety buffer module configured to perform a secondary validation of a permitted indication by cross referencing the geographic location and target time against at least one of permanent tow away zones, emergency routes, and designated no stopping corridors prior to transmitting the permitted indication to the user interface.

14. The system of claim 1, further comprising a community engagement module configured to accept user generated content including reports of availability, sign changes, and temporary restrictions and to use the content to update the signage database or adjust interpretation logic, and a security and privacy module configured to implement encrypted storage of user data, secure communication between devices and servers, anonymization or pseudonymization of location data, and controls to support compliance and, or rule with applicable data protection and privacy regulations.

15. The system of claim 1, wherein generating the binary compliance and, or rule indication comprises evaluating the sign records and associated rule definitions without requiring computation of a probabilistic parking availability metric derived from historical or real time vehicle trajectory data.

16. A computer implemented method for interpreting tangible or intangible sign rules and providing guidance to a user, comprising:
receiving, via a user interface, user input for a sign related query including location information and a target time;
determining, by a location module, a geographic location associated with the user input;
retrieving, from a signage database, sign data associated with the geographic location;
interpreting, by a processing engine, the sign data in view of at least the target time using a rule priority scheme that enforces safety critical restrictions as highest priority to determine whether a specified user action is permitted at the geographic location at the target time; and
outputting, via the user interface, a binary indication of whether the specified user action is permitted together with a textual explanation.

17. The method of claim 16, further comprising receiving, from a time-slider control in the user interface, a future time, updating the target time based on the future time, and recomputing the binary indication and the textual explanation based on the updated target time.

18. The method of claim 16, further comprising refining the geographic location based on metadata comprising at least one of triangulated cell signal data, cellular-carrier data, third-party data, and device-manufacturer data, computing a confidence score for the refined geographic location, and presenting the confidence score together with the binary indication.

19. The method of claim 16, further comprising:
storing, in the signage database, rule vectors each representing a street-segment geospatial region and an associated rule definition specifying at least one of a permitted action, a restricted action, and a time-dependent condition; and
resolving conflicts between overlapping rule vectors by applying rule priority values, including giving precedence to safety critical tow away rules, during the interpreting, wherein the rule vectors are constructed from municipal curb use regulations or sign observations and are not derived by clustering endpoints of vehicle trajectories.

20. The method of claim 16, wherein determining whether the specified user action is permitted excludes reliance on a parking availability probability computed from aggregated vehicle trajectories and instead evaluates only structured tangible or intangible sign rules and associated rule vectors for the geographic location.
